(19) United States
(12) Patent Application Publication
(10) Pub. No.: US 2012/0201176 A1
(43) Pub. Date: Aug. 9, 2012

(54) Method of and Equalizer for Equalizing a Radio Frequency Filter

(75) Inventors: Youping Su, Beijing (CN); Qingyu Miao, Beijing (CN); Chunhui Zhang, Taby (SE)

(73) Assignee: TELEFONAKTIEBOLAGET L M ERICSSON (PUBL), Stockholm (SE)

(21) Appl. No.: 13/501,288

(22) PCT Filed: Oct. 19, 2009
(86) PCT No.: PCT/CN2009/001158

§ 371 Date: Apr. 11, 2012

(51) Int. Cl. H04J 3/00

(52) U.S. Cl. 370/280

(57) ABSTRACT

A method (300) of and an equalizer (104-1, 104-2) for equalizing an RF filter (106-1, 106-2) supporting a frequency band by utilizing an antenna calibration path having the RF filter (106-1, 106-2) in a Node B (100) in a TDD system are provided. The method (300) comprises the steps of obtaining (302) an amplitude and phase response of a calibration signal having a frequency in the frequency band, stepwise changing (304) the frequency of the calibration signal, determining (306) a transfer function of the RF filter (106-1, 106-2), and equalizing (308) the RF filter (106-1, 106-2) based on the determined transfer function of the RF filter (106-1, 106-2).

### TECHNICAL FIELD

The present invention relates generally to a Time Division Duplex (TDD) system and, more particularly, to an equalization of a Radio Frequency (RF) filter by utilizing an antenna calibration path in the TDD system.

### BACKGROUND

In a TDD system such as a Time Division-Synchronous Code Division Multiple Access (TD-SCDMA) system or a Time Division-Long Term Evolution (TD-LTE) system, an RF Filter Unit (FU) with low insertion loss and high stop-band rejection is required to achieve good Adjacent Channel Selectivity (ACS), blocking, and spurious emission performance when the TDD system is in co-location or co-existence with other radio communication system(s).

However, introduction of the high stop-band rejection FU in the TDD system jeopardizes a linearity of an amplitude and phase response of the TDD system and gives rise to high Error Vector Magnitude (EVM) degradation. Since EVM contribution in certain frequency channels of a transmit/receive (TX/RX) filter may be quite large (e.g., in the order of 5%), especially at frequency band edges, it would be beneficial to be able to equalize this at digital baseband.

The prior art has proposed a method of implementing an equalization to compensate for a non-linearity of a transfer function of an FU. In the method, the transfer function is measured in production test of the FU, and then the measured transfer function is stored in a flash memory of the FU or a Remote Radio Unit (RRU) comprising the FU. In operation, the FU is equalized by a Finite Impulse Response (FIR) filter implemented at digital baseband by using the stored transfer function.

Although the above-mentioned method can achieve the equalization of the FU, it still has a number of limitations. Firstly, the transfer function of the FU has to be measured in production and saved in the flash memory of the RRU, which will have an impact on Bill Of Material (BOM) cost of the RRU, especially on that of a multi-path RRU.

Secondly, an additional cabling and measuring procedure is required to measure and save the transfer function of the FU. This adds extra time and complexity at the time of production. For example, in the case of an 8-path RRU for a TDD system, the extra time will be as many as several minutes.

Thirdly, the stored transfer function of the FU is only applicable to a certain temperature. Generally, a working temperature range of an RRU comprising FU(s) is very wide, for example, −40 to 55° C., and a transfer function of an FU drifts due to temperature changes. But the stored transfer function of the FU is measured in production only for a room temperature. Hence, the above-mentioned method applies the measured transfer function for this room temperature to any temperature within the whole working temperature range to make the equalization, which results in some uncertain error.

Fourthly, it becomes complicated to implement the above-mentioned method if the FU is integrated with an antenna and the antenna and an RRU without the FU are from different manufacturers.

### SUMMARY

Therefore, it is an object of the present invention to obviate or mitigate at least some of the above limitations by providing a method of and an equalizer for equalizing an RF filter by utilizing an antenna calibration path having the RF filter in a Node B in a TDD system.

According to one aspect of the present invention, there is provided a method of equalizing an RF filter supporting a frequency band by utilizing an antenna calibration path having the RF filter in a Node B in a TDD system. The method comprises the steps of obtaining an amplitude and phase response of a calibration signal having a frequency in the frequency band by transmitting the calibration signal through the calibration path, stepwise changing the frequency of the calibration signal by sweeping a Local Oscillator (LO) frequency on the calibration path by a predefined step until the amplitude and phase response of the calibration signal in the whole frequency band is obtained, determining a transfer function of the RF filter based on the amplitude and phase response of the calibration signal in the whole frequency band, and equalizing the RF filter based on the determined transfer function of the RF filter.

In an embodiment of the method, equalizing the RF filter based on the determined transfer function of the RF filter comprises determining an FIR filter based on the determined transfer function of the RF filter, and using the FIR filter to equalize the RF filter. Preferably, the FIR filter is located in an RRU comprising the RF filter or a Main Unit (MU) coupled to the RRU.

In an embodiment of the method, the calibration path is a transmitting calibration path or a receiving calibration path.

In an embodiment of the method, the method is executed during a Guard Period (GP) between a Downlink Pilot Time Slot (DwPTS) and an Uplink Pilot Time Slot (UpPTS) in a frame after cell setup.

In an embodiment of the method, the method is executed at the time of cell setup.

In an embodiment of the method, an execution of the method is triggered when a variation in temperature of the RF filter or an RRU comprising the RF filter exceeds a predefined threshold.

In an embodiment of the method, the TDD system is a TD-SCDMA system or a TD-LTE system.

According to another aspect of the present invention, there is provided an equalizer for equalizing an RF filter supporting a frequency band by utilizing an antenna calibration path having the RF filter in a Node B in a TDD system. The equalizer comprises means for obtaining an amplitude and phase response of a calibration signal having a frequency in the frequency band by transmitting the calibration signal through the calibration path, means for stepwise changing the frequency of the calibration signal by sweeping an LO frequency on the calibration path by a predefined step until the amplitude and phase response of the calibration signal in the whole frequency band is obtained, means for determining a transfer function of the RF filter based on the amplitude and phase response of the calibration signal in the whole frequency band, and means for equalizing the RF filter based on the determined transfer function of the RF filter.

In an embodiment of the equalizer, the means for equalizing the RF filter based on the determined transfer function of the RF filter is configured to determine an FIR filter based on the determined transfer function of the RF filter and use the FIR filter to equalize the RF filter. Preferably, the FIR filter is located in an RRU comprising the RF filter or a MU coupled to the RRU.

In an embodiment of the equalizer, the calibration path is a transmitting calibration path or a receiving calibration path.

In an embodiment of the equalizer, the equalizer is configured to operate during a GP between a DwPTS and an UpPTS in a frame after cell setup.

In an embodiment of the equalizer, the equalizer is configured to operate at the time of cell setup.

In an embodiment of the equalizer, the equalizer is configured to be triggered when a variation in temperature of the RF filter or an RRU comprising the RF filter exceeds a predefined threshold.

In an embodiment of the equalizer, the TDD system is a TD-SCDMA system or a TD-LTE system.

According to yet another aspect of the present invention, there is provided a Node B comprising at least the equalizer as stated above.

According to yet another aspect of the present invention, there is provided a TDD system comprising at least the Node B as stated above.

### BRIEF DESCRIPTION OF THE DRAWINGS

The above and other aspects, features and advantages of the present invention will be more apparent from the following more particular description thereof, presented in conjunction with the accompanying drawings, in which:

FIG. 1 is a schematic diagram of a Node B in a TDD system in which one embodiment of the present invention is implemented;

FIG. 2 is a schematic block diagram of one of equalizers for equalizing an RF filter in FIG. 1; and

FIG. 3 schematically shows a flow chart illustrating a method of equalizing the RF filter executed by the one equalizer in FIG. 1.

Corresponding reference characters indicate corresponding components throughout the several views of the drawings.

### DETAILED DESCRIPTION

The embodiments set forth below represent the necessary information to enable those skilled in the art to practice the present invention and illustrate the best mode of the practicing the present invention. Upon reading the following description in light of the accompanying drawing figures, those skilled in the art will understand the concepts of the present invention and will recognize applications of these concepts not particularly addressed herein. It should be understood that these concepts and applications fall within the scope of the disclosure and the accompanying claims.

Throughout the description and claims of this specification, the terminology “Node B” includes, but is not limited to, a base station, a Node-B, an evolved Node-B (eNode-B), or any other type of device with radio transmission/reception capabilities for providing radio coverage in a part of a TDD system.

The principle of the present invention is outlined first.

An antenna comprising antenna elements is employed in a Node B in a TDD system. In order to transmit/receive signals accurately with the antenna, each transmitting/receiving link having a corresponding antennal element should have the same amplitude and phase response.

In general, there is a difference in electrical characteristics among different transmitting/receiving links. This difference is sensitive to operation frequency and ambient temperature. As the operation frequency and/or the ambient temperature change, changes in electrical characteristics of different transmitting/receiving links are different. Hence, a transmitting/receiving calibration of the antenna is generally carried out periodically or as necessary while the Node B is in operation.

A basic concept of the present invention is to obtain a dynamically changed transfer function of an RF filter in the Node B by utilizing a calibration path used in the calibration of the antenna, rather than obtain a fixed transfer function of the RF filter stored in a flash memory of an RRU comprising the RF filter.

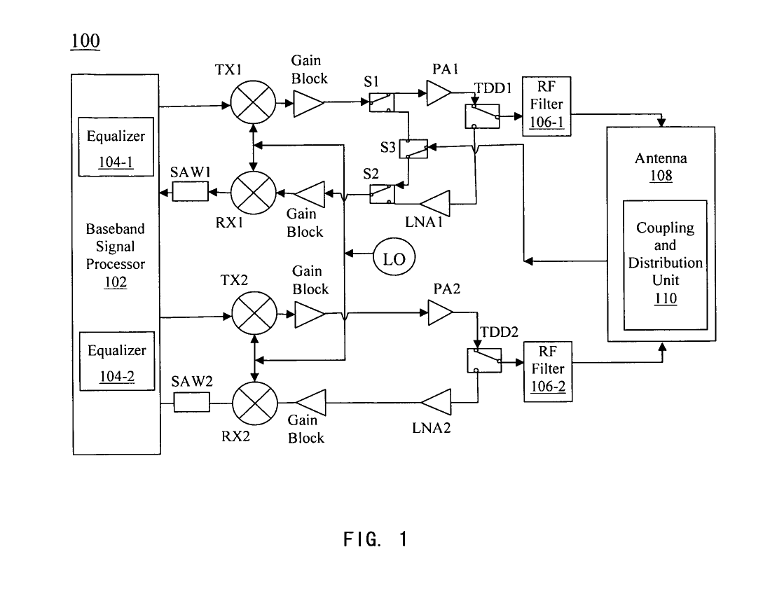

Embodiments of the present invention now will be described in detail by way of example with reference to FIGS. 1-3. FIG. 1 is a schematic diagram of a Node B 100 in a TDD system in which one embodiment of the present invention is implemented.

The Node B 100 comprises a Main Unit (MU) (not shown) and a 2-path RRU (not shown) coupled to the MU. The MU comprises a Base Signal Processor (BSP) 102 including equalizers 104-1 and 104-2. The RRU comprises transmitters TX1 and TX2, receivers RX1 and RX2, an LO, three calibration switches S1, S2 and S3, Power Amplifiers PA1 and PA2, TDD switches TDD1 and TDD2, RF filters 106-1 and 106-2, an antenna 108 including a Coupling and distribution Unit (CDU) 110, Surface Acoustic Wave (SAW) filters SAW1 and SAW2, and other components.

For a transmitting calibration of the antenna 108, there are two calibration paths. A first calibration path includes in a flow direction of a first calibration signal the TX1, the S1, the PA1, the TDD1, the RF filter 106-1, the antenna 108, the S3, the S2, and the RX1. A second calibration path includes in a flow direction of a second calibration signal the TX2, the PA2, the TDD2, the RF filter 106-2, the antenna 108, the S3, the S2, and the RX1.

In the embodiment of the present invention, the two calibration paths as stated above are utilized to obtain transfer functions of the RF filters 106-1 and 106-2.

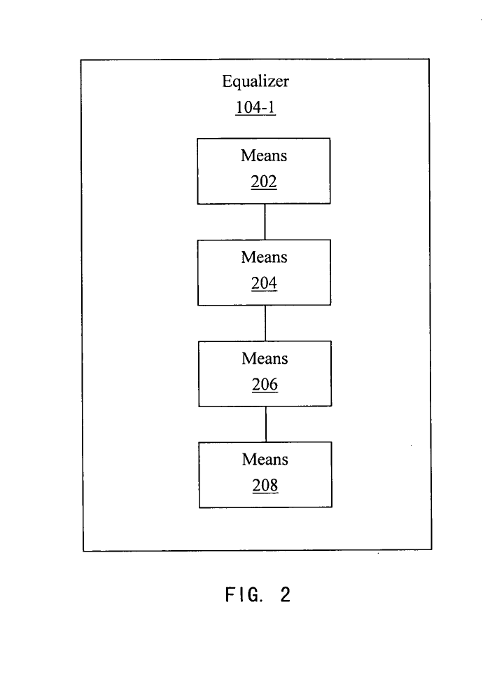

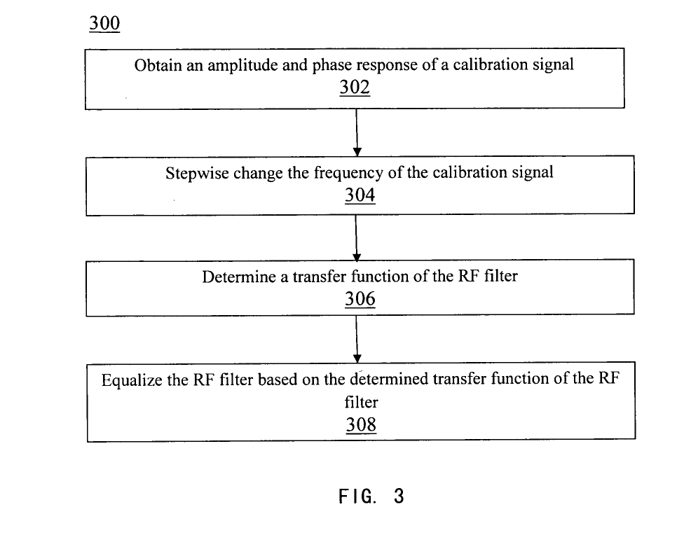

Referring to FIG. 2, there is shown a schematic block diagram of the equalizer 104-1 for equalizing the RF filter 106-1 in FIG. 1. The equalizer 104-1 comprises means 202, 204, 206 and 208. An embodiment of a method 300 of equalizing the RF filter 106-1 executed by the equalizer 104-1 is schematically shown in FIG. 3. Now the embodiment of the method 300 is described below in conjunction with FIGS. 1-2.

It is assumed that a frequency band [f1, f2] is supported by the RRU or the RF filter 106-1. Generally, the method 300 is executed at the time of cell setup. Alternatively or additionally, the execution of the method 300 may be triggered when a variation in temperature of the RF filter 106-1 or the RRU comprising the RF filter 106-1 exceeds a predefined threshold.

The embodiment of the method 300 begins with step 302 in which the means 202 obtains an amplitude and phase response of the first calibration signal having a frequency in the frequency band [f1, f2] by transmitting the first calibration signal through the first calibration path. The status of the calibration switches S1, S2 and S3 and the TDD switch TDD1 is controlled as shown in FIG. 1 to have the first calibration signal travel along the first calibration path.

Then in step 304, the means 204 stepwise changes the frequency of the first calibration signal by sweeping the LO frequency on the first calibration path by a predefined step until the amplitude and phase response of the first calibration signal in the whole frequency band [f1, f2] is obtained.

Then in step 306, the means 206 determines a transfer function of the RF filter 106-1 based on the amplitude and phase response of the first calibration signal in the whole frequency band [f1, f2].

Since all the components except the RF filter 106-1 on the first calibration path are quite linear in the frequency band [f1, f2], both for an amplitude response and for a phase response, the amplitude and phase response with respect to the RF filter 106-1 in the whole frequency band [f1, f2] can be derived. Accordingly, the transfer function of the RF filter 106-1 can be determined.

Moreover, a linearity of an amplitude and phase response of the SAW1 does not affect the determined transfer function, because an Intermediate Frequency (IF) of the RX1 is fixed all the time.

Finally in step 308, the means 208 equalizes the RF filter 106-1 based on the determined transfer function of the RF filter 106-1. For example, the means 208 may determine an FIR filter compensating for a non-linearity of the RF filter 106-1 based on the determined transfer function of the RF filter 106-1 and then use the FIR filter to equalize the RF filter 106-1. As an example, the FIR filter is based on an inverse of the determined transfer function of the RF filter 106-1. It is noted that the FIR filter can be located in the RRU comprising the RF filter 106-1 or the MU coupled to the RRU.

The equalizer 104-2 has the same structure as the equalizer 104-1 and executes a method similar to the method 300 on the second calibration signal passing the second calibration path.

In this way, the RF filters 106-1 and 106-2 can be dynamically tracked and equalized, leading to many advantages. One of the advantages is that the production test time and BOM cost are saved. The transfer function of the RF filter is dynamically determined in real time, thus making it unnecessary to measure and save the transfer function in advance.

Another advantage is that the transfer function of the RF filter can be adapted to the whole working temperature range of the RRU, because the transfer function is dynamically determined in response to temperature changes.

A further advantage is that the equalizer can work even when the RF filter is not comprised in the RRU and instead integrated with an antenna from other manufacturer.

It should be noted that the 2-path RRU is shown in FIG. 2 only as an example. The same principle of the present invention applies to a 4-, 6-, or 8-path RRU, for example. Further, the transmitting calibration paths in FIG. 2 are utilized in the embodiment of the present invention. Similarly, the receiving calibration paths can also be utilized in the embodiment of the present invention.

Additionally, in practice, it is not likely for the Node B 100 to run in full load all the time. There would always be some idle gaps which can be used for the execution of the method 300 of the present invention. In a TDD system, the method 300 of the present invention may be executed during a Guard Period (GP) between a Downlink Pilot Time Slot (DwPTS) and an Uplink Pilot Time Slot (UpPTS) in a frame after cell setup.

Throughout the description and claims of this specification, the words “comprise”, “include”, and variations of the words, for example “comprising” and “comprises”, means “including but not limited to”, and is not intended to (and does not) exclude other components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

It will be understood that the foregoing description of the embodiments of the present invention has been presented for purposes of illustration and description. This description is not exhaustive and does not limit the claimed invention to the precise forms disclosed. Modifications and variations are possible in light of the above description or may be acquired from practicing the present invention. The claims and their equivalents define the scope of the present invention.

1.-18. (canceled)

19. A method of equalizing a Radio Frequency (RF) filter in a Node B in a Time Division Duplex (TDD) system, the RF filter supporting a frequency band and forming a portion of an antenna calibration path, the method comprising an equalization procedure comprising:
obtaining an amplitude and phase response of a calibration signal having a frequency in the frequency band by transmitting the calibration signal through the calibration path;
stepwise changing the frequency of the calibration signal by sweeping a Local Oscillator frequency on the calibration path by a predefined step until the amplitude and phase response of the calibration signal in the whole frequency band is obtained;
determining a transfer function of the RF filter based on the amplitude and phase response of the calibration signal in the whole frequency band;
equalizing the RF filter based on the determined transfer function of the RF filter.

20. The method of claim 19 wherein equalizing the RF filter based on the determined transfer function of the RF filter comprises:
determining a Finite Impulse Response (FIR) filter based on the determined transfer function of the RF filter;
using the FIR filter to equalize the RF filter.

21. The method of claim 20 wherein the FIR filter is located in one of:
a Remote Radio Unit (RRU) comprising the RF filter; or
a Main Unit coupled to the RRU.

22. The method of claim 19 wherein the calibration path is a transmitting calibration path or a receiving calibration path.

23. The method of claim 19 further comprising executing the equalization procedure during a Guard Period between a Downlink Pilot Time Slot and an Uplink Pilot Time Slot in a frame after cell setup.

24. The method of claim 19 further comprising executing the equalization procedure during a cell setup procedure.

25. The method of claim 19 further comprising triggering the equalization procedure in response to a variation in temperature exceeding a predefined threshold in one of:
the RF filter; or
a Remote Radio Unit comprising the RF filter.

26. The method of claim 19 wherein the TDD system is a Time Division-Synchronous Code Division Multiple Access system or a Time Division-Long Term Evolution system.

27. An equalizer for equalizing a Radio Frequency (RF) filter in a Node B in a Time Division Duplex (TDD) system, the RF filter supporting a frequency band and forming a portion of an antenna calibration path, the equalizer configured to perform an equalization procedure that comprises:
obtaining an amplitude and phase response of a calibration signal having a frequency in the frequency band by transmitting the calibration signal through the calibration path;
stepwise changing the frequency of the calibration signal by sweeping a Local Oscillator frequency on the calibration path by a predefined step until the amplitude and phase response of the calibration signal in the whole frequency band is obtained;
determining a transfer function of the RF filter based on the amplitude and phase response of the calibration signal in the whole frequency band;
equalizing the RF filter based on the determined transfer function of the RF filter.

28. The equalizer of claim 27:
wherein the equalization procedure comprises determining a Finite Impulse Response (FIR) filter based on the determined transfer function of the RF filter;
wherein the equalizing the RF filter comprises equalizing the RF filter based on the FIR filter.

29. The equalizer of claim 28 wherein the FIR filter is located in a Remote Radio Unit comprising the RF filter or a Main Unit coupled to the RRU.

30. The equalizer of claim 27 wherein the calibration path is a transmitting calibration path or a receiving calibration path.

31. The equalizer of claim 27 wherein the equalizer is configured to perform the equalization procedure during a Guard Period between a Downlink Pilot Time Slot and an Uplink Pilot Time Slot in a frame after cell setup.

32. The equalizer of claim 27 wherein the TDD system is a Time Division-Synchronous Code Division Multiple Access system or a Time Division-Long Term Evolution system.

33. A Node B in a Time Division Duplex system, the Node B comprising:
a Radio Frequency (RF) filter supporting a frequency band;
an antenna calibration path that includes the RF filter;
an equalizer; the equalizer configured to perform an equalization procedure comprising:
obtaining an amplitude and phase response of a calibration signal having a frequency in the frequency band by transmitting the calibration signal through the calibration path;
stepwise changing the frequency of the calibration signal by sweeping a Local Oscillator frequency on the calibration path by a predefined step until the amplitude and phase response of the calibration signal in the whole frequency band is obtained;
determining a transfer function of the RF filter based on the amplitude and phase response of the calibration signal in the whole frequency band;
equalizing the RF filter based on the determined transfer function of the RF filter.
